(19) United States
(12) Patent Application Publication
(10) Pub. No.: US 2023/0102679 A1
(43) Pub. Date: Mar. 30, 2023

(54) Battery Recycling Method

(71) Applicant: Pure Lithium Corporation, Charlestown, MA (US)

(72) Inventors: Donald R. Sadoway, Cambridge, MA (US); Paul J. Burke, Framingham, MA (US)

(21) Appl. No.: 17/951,693

(22) Filed: Sep. 23, 2022

Related U.S. Application Data
(60) Provisional application No. 63/248,704, filed on Sep. 27, 2021.

(51) Int. Cl. H01M 10/54; C25C 3/02; C25C 3/30; C25C 7/00

(52) U.S. Cl. CPC H01M 10/54; C25C 3/02; C25C 3/30; C25C 7/005

(57) ABSTRACT

Methods are proposed for extracting transition metal oxides from scrap batteries by dissolving the metal oxides in a glass-forming oxide melt, followed by electrolytic reduction of the transition metal onto the cathode of an electrolytic cell. Suitable glass-forming oxide melts include borate and pyrophosphate melts with added Na₂O or NaF. The method is particularly suited to the recovery of cobalt, nickel, and manganese from scrap battery and electronic materials. A preferred recycling process includes first recovering lithium metal from scrap battery material, and then extracting transition metal oxides from the lithium-depleted material.

### CROSS-REFERENCE TO RELATED APPLICATIONS

This patent application claims the benefit of U.S. Provisional Patent Application No. 63/248,704 filed Sep. 27, 2021, which application is hereby incorporated, in its entirety, by reference.

### TECHNICAL FIELD

The present invention relates to the cost-effective and environmentally benign recovery of transition metals from battery scrap, in particular from rechargeable lithium battery electrodes.

### BACKGROUND ART

Lithium ion batteries (LIBs) are ubiquitous in consumer electronics, and power electrical vehicles. Battery lifetimes are typically less than three years in consumer electronics, and between five to ten years in electric vehicles. With an estimated 140 million electric vehicles predicted to be on the road by 2030, the demand for LIBs is growing by leaps and bounds—as is the demand for the critical metals required for LIB manufacture. In addition to lithium, critical metals present as metal oxides in the cathodes of lithium-ion batteries include cobalt, manganese, and nickel. Cobalt is present at a concentration of up to 15% in lithium ion battery cathodes, and contributes significantly to the cost of battery production. The primary sources of cobalt are from regions associated with human rights concerns and political instability. Cobalt is also associated with environmental toxicity, which needs to be considered for any proposed recycling methods.

And yet less than 5% of lithium ion batteries are currently recycled, with the majority ending up in landfills, wasting valuable resources, and potentially leaching heavy metals. Urgent economic and environmental needs exist for improved methods of recovery of high value metals from batteries.

### SUMMARY OF THE EMBODIMENTS

According to embodiments of the instant invention, a process is disclosed for recycling battery scrap containing one or more transition metal oxides. In a preferred embodiment, the process includes the steps of submerging the battery scrap in a melt comprising a glass-forming oxide, holding the melt at a temperature between about 600° C. and about 1100° C., thereby allowing the one or more transition metal oxides to dissolve in the melt, disposing an anode and a first cathode in the melt, and applying a voltage across the anode and the first cathode, thereby generating oxygen at the anode and electroplating a first transition metal onto the first cathode.

In some embodiments, the process for recycling battery scrap includes the further steps of monitoring electrical properties to determine when the first transition metal has been depleted from the melt, wherein the electrical properties monitored are selected from the group consisting of current, voltage, time derivatives of current, time derivatives of voltage, and combinations thereof, followed by removal of the first cathode with first electroplated transition metal from the melt.

According to some such embodiments, the voltage is applied in order to maintain a constant current until a rise in voltage indicates depletion of the first transition metal oxide from the melt, followed by removal the first cathode with first electroplated transition metal from the melt.

In some embodiments, the process for recycling battery scrap further includes the steps of disposing a second cathode in the melt, applying a voltage across the anode and the second cathode, thereby generating oxygen at the anode and electroplating a second transition metal onto the second cathode, monitoring electrical properties to determine when the second transition metal has been depleted from the melt, wherein the electrical properties monitored are selected from the group consisting of current, voltage, time derivatives of current, time derivatives of voltage, and combinations thereof, and removing the second cathode with second electroplated transition metal from the melt.

In some embodiments, the process further includes continuing to apply voltage, electroplating successive transition metals on additional cathodes based on monitoring of electrical properties to determine depletion of successive transition metals, and removing successive cathodes with successive electroplated transition metals from the melt, wherein the electrical properties monitored are selected from the group consisting of current, voltage, time derivatives of current, time derivatives of voltage, and combinations thereof

According to some preferred embodiments of the instant invention, a process is disclosed for recycling battery scrap containing one or more transition metal oxides, the process including the steps of submerging the battery scrap in a melt comprising a glass-forming oxide, the melt being contained in an extraction cell, holding the melt at a temperature between about 600° C. and about 1100° C., thereby allowing the oxides of the one or more transition metals to dissolve in the melt, configuring a liquid metal cathode in the melt, the liquid metal cathode being liquid metal at the temperature of the melt, configuring an anode in the melt, applying a voltage across the anode and the liquid metal cathode, thereby generating oxygen at the anode and reducing the one or more transition metals at the liquid metal cathode, the reduced transition metals thereby forming a liquid metal alloy with the liquid metal in the liquid metal cathode, and processing the liquid metal alloy to extract the one or more transition metals from the liquid metal alloy.

According to some such embodiments, processing the liquid metal alloy to extract the one or more transition metals includes the refining steps of pooling the liquid metal alloy containing the one or more transition metals at the bottom of a refiner cell, the refiner cell further having a molten salt covering the pooled liquid metal alloy, wherein the liquid metal alloy is electrically configured as an anode in the refiner cell, wherein the melting temperature of the molten salt electrolyte is less than 300° C., and wherein the operating temperature of the refiner cell is greater than the melting temperature of the molten salt electrolyte and of the liquid metal alloy but less than the melting temperatures of the one or more transition metals that are present in the liquid metal alloy, configuring a first electrically conductive substrate to function as a first refiner cell cathode, passing a current across the first electrically conductive substrate and the liquid metal alloy, causing a first transition metal to electroplate onto the first electrically conductive substrate.

According to some such embodiments, the process further comprises the steps of monitoring electrical properties to determine when the first transition metal has been depleted from the molten salt electrolyte, removing the first electrically conductive substrate coated with the first transition metal in order to recover the first transition metal in pure form, wherein the electrical properties monitored are selected from the group consisting of current, voltage, time derivatives of current, time derivatives of voltage, and combinations thereof.

According to some such embodiments, the process includes the further steps of configuring a second electrically conductive substrate to function as a second refiner cell cathode, passing a current across the second electrically conductive substrate and the liquid metal alloy, causing a second transition metal to electroplate onto the second electrically conductive substrate.

According to some such embodiments, the process includes the further steps of monitoring electrical properties to determine when the second transition metal has been depleted from the molten salt electrolyte, removing the second electrically conductive substrate coated with the second transition metal in order to recover the second transition metal in pure form, wherein the electrical properties monitored are selected from the group consisting of current, voltage, time derivatives of current, time derivatives of voltage, and combinations thereof.

According to some such embodiments, the process includes the further steps of configuring successive electrically conductive substrates to function as successive refiner cell cathodes, passing a current across successive electrically conductive substrates and the liquid metal alloy, causing successive transition metals to electroplate onto successive electrically conductive substrates, monitoring electrical properties to determine when the successive transition metals have been depleted from the molten salt electrolyte, removing successive electrically conductive substrates coated with successive transition metals in order to recover successive transition metals in pure form, wherein the electrical properties monitored are selected from the group consisting of current, voltage, time derivatives of current, time derivatives of voltage, and combinations thereof.

According to some embodiments, the glass-forming oxide used in the process for recycling battery scrap containing one or more transition metal oxides is selected from the group consisting of borate, pyrophosphate, silicate, and combinations thereof In some embodiments, the glass-forming oxide melt includes Na2O. In some embodiments, the glass-forming oxide melt includes NaF.

In some embodiments the glass-forming oxide melt is composed primarily of borate. In some embodiments the glass-forming oxide melt is composed primarily of pyrophosphate.

According to some embodiments, the one or more transition metals forming the transition metal oxide are selected from the group consisting of cobalt, nickel, manganese, and combinations thereof. According to preferred embodiments, the battery scrap includes material from lithium batteries. According to some such embodiments, the battery scrap includes lithium depleted battery scrap.

According to some embodiments of the instant invention, a process is disclosed for obtaining lithium metal and lithium depleted battery scrap from battery scrap containing lithium in ionic or metallic form. According to such embodiments, the process includes the steps of configuring the battery scrap as an anode in an electrolytic cell, configuring an electrically conductive substrate as a cathode in the electrolytic cell, the electrically conductive substrate being coated with a lithium ion selective elastomeric polymer, disposing a molten salt electrolyte in the electrolytic cell, such that the anode and the elastomeric polymer coated electrically conductive substrate are submerged in the molten salt electrolyte, wherein the melting temperature of the molten salt electrolyte is less than 140° C., applying a voltage across the anode and the electrically conductive substrate, the voltage causing a layer of lithium metal to deposit on the surface of the electrically conductive substrate, with the layer of lithium metal being sandwiched between the electrically conductive substrate and the elastomeric polymer coating, thereby providing the lithium metal in a form suitable for further processing, and the lithium depleted battery scrap.

According to some embodiments, the lithium depleted battery scrap obtained in this manner is then further processed according to steps including removing the lithium depleted battery scrap from the first molten salt electrolyte, submerging the lithium depleted battery scrap in a melt comprising a glass-forming oxide, the melt being contained in an extraction cell, holding the melt at a temperature that allows the oxides of the one or more transition metals to dissolve in the melt, configuring a second cathode in the melt, configuring a second anode in the melt, applying a voltage across the second anode and the second cathode, thereby generating oxygen at the anode and reducing the one or more transition metals at the cathode for recovery.

### BRIEF DESCRIPTION OF THE DRAWINGS

The foregoing features of embodiments will be more readily understood by reference to the following detailed description, taken with reference to the accompanying drawings, in which:

FIG. 1 embodies a method of extracting transition metals from lithium battery cathodes by dissolution in a glass-forming oxide melt and recovery of the extracted metal by electroplating.

FIG. 2 embodies an extraction vessel configured to extract transition metal oxide from scrap material by dissolution in a glass-forming oxide melt.

FIG. 3 embodies an electrolytic cell configured to electroplate transition metal that has been dissolved in a glass-forming oxide melt onto a cathode. Oxygen is produced at the anode of the electrolytic cell.

FIG. 4 embodies an extraction cell configured to reduce transition metal oxides to elemental transition metals onto a molten metal cathode, thereby forming a liquid alloy with the molten metal cathode, and generating oxygen at the anode.

FIG. 5 embodies a refining cell for electroplating transition metals onto an electrically conductive substrate configured as a cathode. The cell is shown prior to electrolysis.

FIG. 6 embodies a refining cell of FIG. 5 upon completion of electrolysis.

FIG. 7 embodies a method of extracting lithium from lithium battery scrap, prior to extracting transition metal from the scrap.

FIG. 8 embodies an electrolytic cell for recovering lithium from lithium battery scrap and providing lithium depleted battery scrap for further processing. The cell is shown prior to electrolysis.

FIG. 9 embodies the electrolytic cell of FIG. 8 upon completion of electrolysis.

### DETAILED DESCRIPTION OF SPECIFIC EMBODIMENTS

Definitions. As used in this description and the accompanying claims, the following terms shall have the meanings indicated, unless the context otherwise requires:

A “lithium battery” is a lithium-ion or a lithium metal battery.

A “glass-forming oxide” is an oxide capable of forming a glass when cooled from the molten state. Examples of glass-forming oxides include borate (B₂O₃) and pyrophosphate (Na₄P₂O₇).

A “glass-forming oxide melt” is a high temperature molten state of a glass forming oxide, which may include dissolved compounds such as Na₂O, NaF, and salts of transition metal oxides.

Borate and pyrophosphate glasses form melts at modest temperatures (below 1100° C.), and when these melts include one or both of Na₂O and NaF, they can dissolve relatively large amounts of certain transition metal oxides. As an added benefit, the addition of Na₂O and NaF reduces the viscosity of melts of borate and pyrophosphate glasses. Grigorenko has shown that zirconium oxide dissolves in melts of borate and pyrophosphate glasses and can be electrolytically plated from such melts. (F. F. Grigorenko and L. I. Savrans'kii, “Electrochemical investigation of zirconium dioxide in fluoride-borate melts,” Visn. Kiivs'k. Univ. Ser. Astron., Fiz. to Khim., Vol. 1, No. 5, 136-139 (1962); F. F. Grigorenko and B. I. Danil'tsev, “Solubility of zirconium dioxide in molten sodium diphosphate,” Visnyk Kyivs'k. Univ., Ser. Khim., Vol. 8, 73-76 (1967)). In this work, Grigorenko found that ZrO₂ solubility was enhanced for both borate melts and pyrophosphate melts by the presence of NaF. Amietszajew examined the solubility of nickel oxide, cobalt oxide, and manganese oxide in borate melts and found enhanced solubility in the presence of Na₂O. (T. Amietszajey, S. Seetharaman and R. Bhagat, “The solubility of specific metal oxides in molten borate glass,” J. Am. Ceram. Soc., Vol 98, 2984-2987 (2015)).

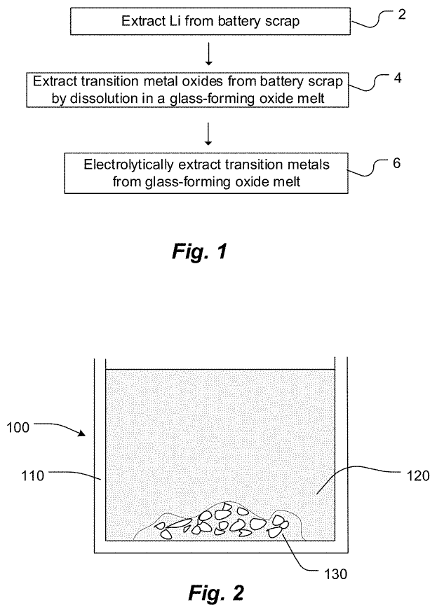

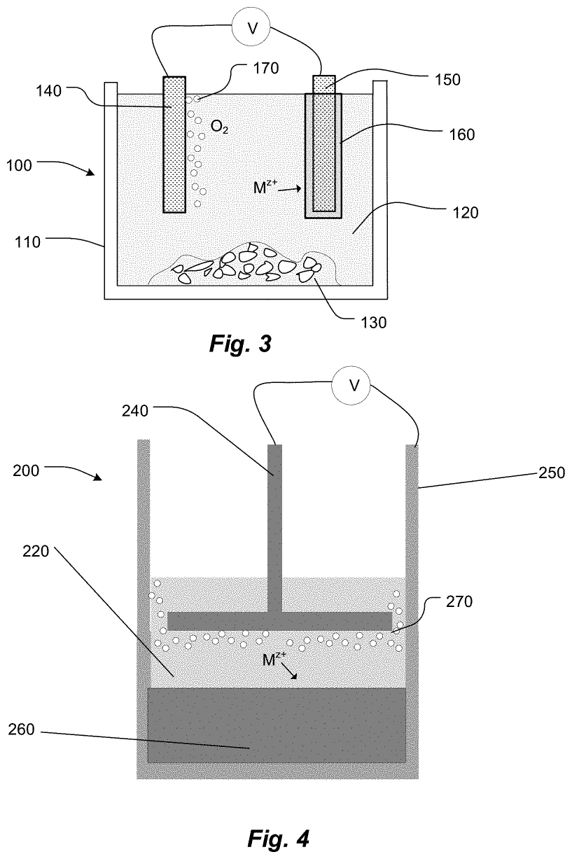

As embodied in FIG. 1, a general method of recycling lithium battery scrap is embodied in FIG. 1. An optional first step is to extract lithium from the battery scrap 2, leaving lithium depleted battery scrap. Next, the battery scrap, optionally depleted of lithium, is immersed in a glass-forming oxide melt, and one or more transition metal oxides present in the lithium battery scrap are dissolved into the melt 4. Electrodes are then disposed in the melt and the one or more transition metals are extracted by electrolysis 6. Two distinct electrolytic methods of extracting the one or more transition metals from the melt are embodied in FIGS. 3 and 4-6, respectively.

As embodied in FIG. 2, battery scrap 130, optionally depleted of lithium, is placed in a dissolution chamber 100 with insulating walls 110. The battery scrap 130 is dispersed in a glass-forming oxide melt 120, contained within the insulating walls 110, and kept at a temperature between about 600° C. and about 1100° C. In a preferred embodiment, the battery scrap 130 is continuously mixed with the glass-forming oxide melt 120 within the dissolution chamber 100.

In some embodiments, the glass-forming oxide melt 120 is maintained at a temperature of between 600° C. and 1100° C. In some embodiments, the glass-forming oxide melt 120 is maintained at a temperature of between 600° C. and 700° C. In some embodiments, the glass-forming oxide melt 120 is maintained at a temperature of between 700° C. and 800° C. In some embodiments, the glass-forming oxide melt 120 is maintained at a temperature of between 800° C. and 900° C. In some embodiments, the glass-forming oxide melt 120 is maintained at a temperature of between 900° C. and 1000° C. In some embodiments, the glass-forming oxide melt 120 is maintained at a temperature of between 1000° C. and 1100° C.

After sufficient time is allowed for dissolution of the one or more transition metal oxides, controlled electrolytic extraction allows recovery of the one or more transition metals from the glass-forming oxide melt. A first method of electrolytic recovery is embodied in FIG. 3. A second method is embodied in FIGS. 4-6.

According to the method embodied in FIG. 3, the glass-forming oxide melt 120 with dissolved transition metal oxide is maintained at a temperature of between 600° C. and 1100° C. An anode 140 and an electrically conducting substrate 150 configured as a cathode are disposed within the glass-forming oxide melt 120. Voltage applied across the anode 140 and the electrically conducting substrate 150 results in electroplating of transition metal 160 onto the electrically conducting substrate 150 and the generation of oxygen gas 170 at the anode 140.

Electroplating of transition metals from the glass-forming oxide melt will occur in order of increasing reduction potential for the transition metal oxides in the glass-forming oxide melt 120. While generally, as voltage is applied, less electropositive (more nobel) metals will plate first, followed by more electropositive transition metals, other factors, including the solvation free energy of the dissolved metal oxide in the glass-forming oxide melt 120, may influence the reduction potential, and thus the order of electroplating.

In a preferred embodiment, monitored changes in electrical properties signal the depletion of a first dissolved metal oxide from the oxide melt 120, and the end of electroplating of the transition metal 160 of that first transition metal oxide. In this embodiment, when the first transition metal 160 is plated, as judged by monitored changes in electrical properties, a first electrically conductive substrate 150 onto which plating has occurred, is removed from the oxide melt, allowing for recovery of the first plated transition metal 160.

In some embodiments, at this point a second electrically conductive substrate 150 is disposed in the electrolytic cell, and connected as the cathode of the cell. Voltage continues to be applied until monitored changes in electrical properties indicate that a second transition metal 160 has plated onto the second electrically conductive substrate 150, at which point the second electrically conductive substrate 150, is removed from the cell for recovery of the electroplated second transition metal 160.

In further embodiments, successive transition metals are electroplated onto successive electrically conductive substrates 150, allowing for their removal and recovery.

In preferred embodiments, a large change or discontinuity in electrical properties provides the signal that a transition metal has electroplated. A variety of electrical properties can provide such a signal, including any or all of current, voltage, time derivatives of current, time derivatives of voltage, and combinations thereof.

In a preferred embodiment, voltage is adjusted to maintain constant current, and a jump in voltage at constant current signals the depletion of one metal oxide from the glass-forming oxide melt 120, and the completion of electroplating of the metal associated with that metal oxide onto a conductive substrate 150.

In preferred embodiments, voltage can continue to be applied to remove successive transition metals in the order of increasing reduction potential, until all transition metals that are initially present as transition metal oxides in the lithium battery scrap are depleted from the glass-forming oxide melt 120, and reduced to metallic form.

In some embodiments, the lithium battery scrap has been pre-sorted to include only lithium cobalt oxide (LCO) batteries. For such batteries, the only transition metal oxides present are cobalt oxides, and electroplating according to the method embodied in FIG. 3 will result in the electroplating of cobalt onto a single conductive substrate.

In some embodiments, the lithium battery scrap will include lithium nickel manganese cobalt (NMC) batteries with mixed oxides of nickel, manganese, and cobalt. For such lithium battery scrap, application of the method of FIG. 3 will result in successive electroplating of cobalt, nickel and manganese onto electrically conductive substrates in the order from the lowest to the highest reduction potential. Due to its highly electropositive nature, manganese will always plate last, but the order of cobalt and nickel electroplating may vary depending on the experimental parameters and the composition of the glass-forming oxide.

According to the method embodied in FIGS. 4 to 6, transition metals are extracted from the glass-forming oxide melt 120 with dissolved transition metal oxide according to a two-step process. In the first step, embodied in FIG. 4, an extraction cell 200 is configured with a liquid metal cathode 260 disposed at the bottom of the cell. The liquid metal cathode 260 contacts an electrically conductive substrate 250. Glass-forming oxide melt 220 is disposed on top the liquid metal cathode 260. An anode 240 is disposed within the glass-forming oxide melt. The electrolytic cell 200 is maintained at a temperature of between 600° C. and 1100° C. Voltage applied across the anode 240 and the electrically conducting substrate 250 results in the reduction of any transition metal oxides to metallic transition metal at the liquid metal cathode 260 and the generation of oxygen gas 270 at the anode 240. The reduced transition metals form a liquid metal alloy with the liquid metal of the cathode 260.

In some embodiments, the liquid metal cathode 260 is predominantly tin. In some embodiments, the liquid metal cathode 260 is predominantly bismuth. In some embodiments, the liquid metal cathode 260 is an alloy composed predominantly of tin and bismuth. In preferred embodiments, the melting point of the liquid metal cathode 260 is less than 300° C.

In some embodiments, the transition metal oxides initially present in the battery scrap include oxides of cobalt, nickel, and manganese. For such embodiments, following the first step of the process embodied in FIG. 4, the liquid metal alloy includes elemental cobalt, nickel, and manganese.

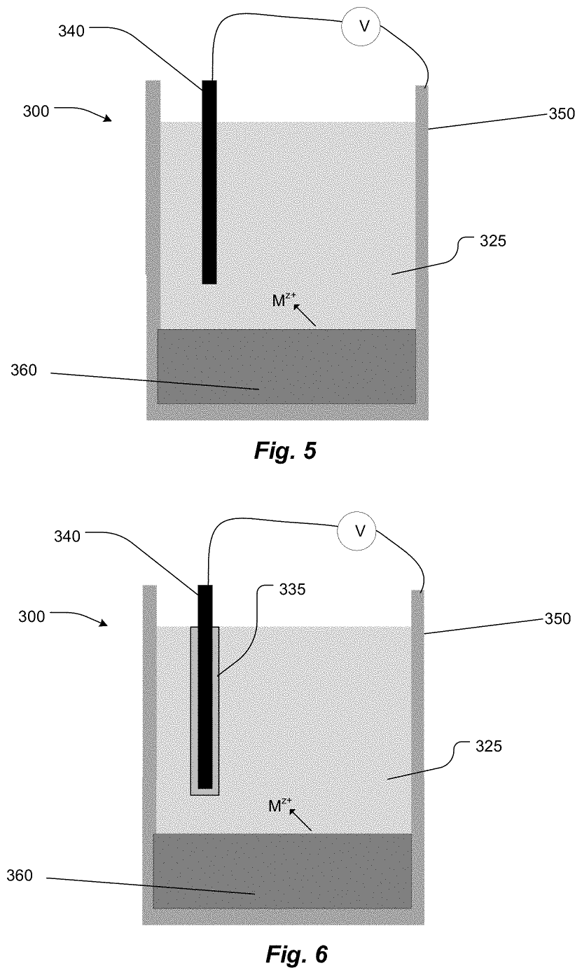

The second step of the method is embodied in FIGS. 5 and 6. According to this step, the liquid metal alloy is now configured as an anode 360 in a refiner cell 300. Resting atop the liquid metal alloy anode 360 is a molten salt electrolyte 325, comprising salts of metals that are more electropositive than the transition metals present in the liquid metal alloy. As embodied in FIG. 5, an electrically conductive, inert substrate is configured as a cathode 340 in the molten salt electrolyte 325. According to this embodiment, the operating temperature of the refiner cell 300 is greater than the melting temperature of the molten salt electrolyte 325 and of the liquid metal alloy anode 360 but less than the melting temperature of the one or more transition metals present in the liquid metal alloy anode 360.

As embodied in FIG. 6, the application of voltage and passage of current across the cathode 340 and the liquid metal anode 360 by means of an electrically conductive anode connector 350 causes a layer of transition metal 335 to electroplate on the cathode. Because the transition metals with the highest reduction potential are the first to oxidize, they will also be the first to electroplate, and transition metals will electroplate onto the cathode 340 in order of decreasing reduction potential in the molten salt system.

In a preferred embodiment, following electroplating of a first transition metal, the cathode 340 is removed from solution to collect the pure metal form of the first transition metal. In some embodiments, a new cathode 340 is then configured in the refiner cell 300, and a second transition metal is electroplated. Once the second transition metal is electroplated and the cathode 340 with layer of transition metal is removed, then another cathode 340 may be inserted to collect the third transition metal, and the process of electroplating, removing cathode for collection, and electroplating is continued until all transition metals initially present in the liquid metal anode 360 are extracted.

In preferred embodiments, in order to determine when a given transition metal is completely electroplated, electrical properties can be monitored, with suitable electrical properties including current, voltage, time derivatives of current, time derivatives of voltage, and combinations thereof. In some embodiments, voltage can be monitored at constant current, and an abrupt change in voltage will signal completion of electroplating of the given transition metal.

In some embodiments, the transition metal with the greatest reduction potential is manganese, the second greatest reduction potential is cobalt, and the third greatest reduction potential is nickel, and the cathodes in the refining cell are electroplated in the order manganese, cobalt, and nickel.

In some embodiments, the molten salt electrolyte 325 includes a combination of one or more halide salts of alkali cations, alkaline earth cations, and NH₄⁺. In preferred embodiments, the molten salt electrolyte 325 includes one or more of LiCl, NaCl, KCl, NH₄Cl, MgCl₂, CaCl₂, SrCl₂, and BaCl₂.

In some embodiments, the lithium battery scrap 130 is presorted to separate cathodes and anodes, and only the cathode-containing scrap is used to recover transition metals.

In some embodiments, the glass forming oxide melt is predominantly B₂O₃. In some embodiments, the melt is predominantly pyrophosphate. In some embodiments the melt includes one or more of Na₂O and NaF. In a preferred embodiment, the melt is predominantly B₂O₃, and the molar ratio of B₂O₃ to Na₂O is greater than about 2:1.

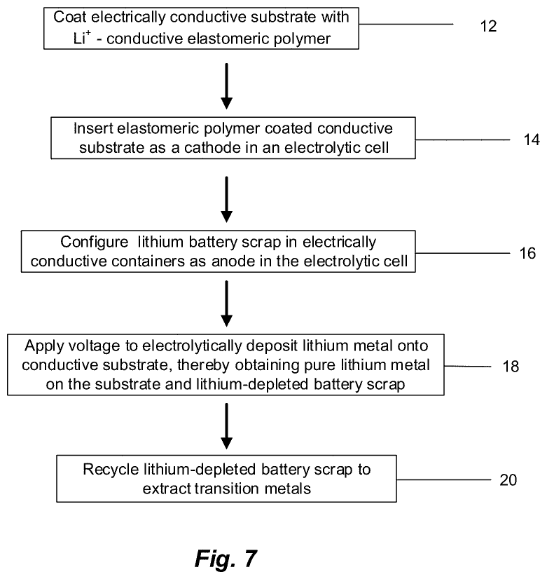

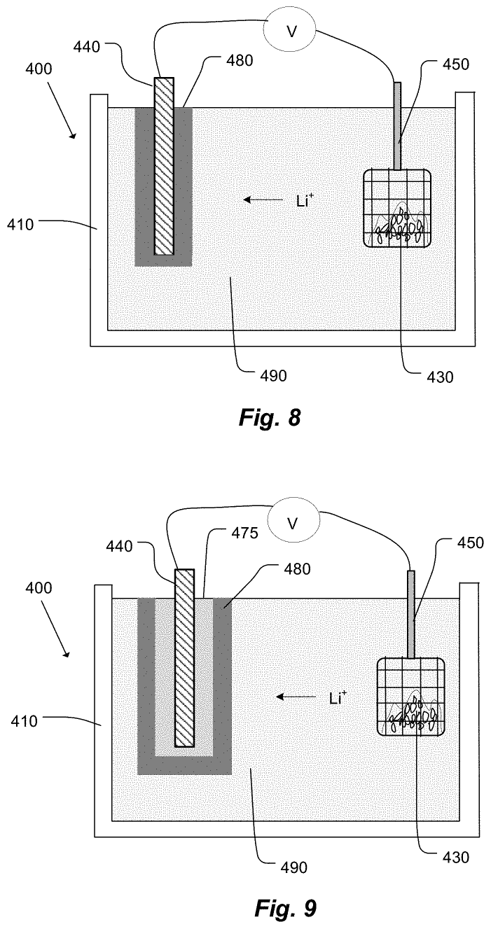

In some embodiments, the battery scrap from which transition metal is extracted is first depleted of lithium. In some embodiments, the lithium is depleted electrolytically. In some embodiments the lithium is stripped electrolytically by the procedure set forth in FIG. 7, using the electrolytic cell embodied in FIGS. 8 and 9. Details of electrolytic processes suitable for this procedure are described in Appendices A and B.

According to the method of FIG. 7, an electrically conductive substrate is coated with an elastomeric polymer that is selectively conductive of lithium ion. 12. The elastomeric polymer coated electrically conductive substrate is then configured as a cathode in an electrolytic cell. 14. Lithium battery scrap in electrolyte-permeable electrically conductive containers is configured as an anode in the electrolytic cell. 16. Upon application of voltage, lithium metal is electrolytically deposited onto a conductive substrate, thereby obtaining both pure lithium metal on the substrate and lithium-depleted battery scrap. 18. The lithium-depleted battery scrap then provides the substrate for the extraction of transition metals by processes such as those embodied in FIGS. 1 through 6. 20.

An electrolytic cell 400 for performing the method of FIG. 7 is shown in FIGS. 8 and 9. The cell includes a cell wall 410. Disposed within the cell wall 410 are a lithium-ion selective elastomeric polymer coated electrically conductive substrate 440, configured as a cathode, an electrolyte 490, and an electrically conductive basket 450, immersed in the electrolyte 490, and containing lithium battery scrap 430, the electrically conductive basket 450 being permeable to the electrolyte 490, and allowing immersion of the battery scrap 430 in the electrolyte. The electrically conductive basket 450, together with the lithium battery scrap 430 are configured as an anode in the electrolytic cell 400.

As embodied in FIG. 9, as voltage is applied across the electrically conductive substrate 440, and the electrically conductive basket 450 containing lithium battery scrap 430, lithium ions flow through the electrolyte solution and selectively electroplate on the electrically conductive substrate 440, forming a layer of lithium metal 475, and depleting the lithium battery scrap 430 of lithium.

Upon depletion of lithium, the lithium battery scrap 430 provides lithium-depleted battery scrap suitable for transition metal extraction according to above-described embodiments.

The treatment of battery scrap to remove lithium, as embodied in FIGS. 7-9, followed by the extraction of transition metals as embodied in FIGS. 1-6, provide a complete recycling solution for lithium batteries.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A process for recycling battery scrap containing one or more transition metal oxides comprising:
submerging the battery scrap in a melt comprising a glass-forming oxide;
holding the melt at a temperature between about 600° C. and about 1100° C., thereby allowing the one or more transition metal oxides to dissolve in the melt;
disposing an anode and a first cathode in the melt; and
applying a voltage across the anode and the first cathode, thereby generating oxygen at the anode and electroplating a first transition metal onto the first cathode.

2. The process for recycling battery scrap according to claim 1, further comprising:
monitoring electrical properties to determine when the first transition metal has been depleted from the melt, wherein the electrical properties monitored are selected from the group consisting of current, voltage, time derivatives of current, time derivatives of voltage, and combinations thereof; and
removing the first cathode with first electroplated transition metal from the melt.

3. The process for recycling battery scrap according to claim 2, further comprising:
disposing a second cathode in the melt;
applying a voltage across the anode and the second cathode, thereby generating oxygen at the anode and electroplating a second transition metal onto the second cathode;
monitoring electrical properties to determine when the second transition metal has been depleted from the melt, wherein the electrical properties monitored are selected from the group consisting of current, voltage, time derivatives of current, time derivatives of voltage, and combinations thereof; and
removing the second cathode with second electroplated transition metal from the melt.

4. The process for recycling battery scrap according to claim 3, further comprising:
continuing to apply voltage, electroplating successive transition metals on additional cathodes based on monitoring of electrical properties to determine depletion of successive transition metal, and removing successive cathodes with successive electroplated transition metals from the melt, wherein the electrical properties monitored are selected from the group consisting of current, voltage, time derivatives of current, time derivatives of voltage, and combinations thereof.

5. The process for recycling battery scrap according to claim 1, wherein the voltage is applied in order to maintain a constant current.

6. The process for recycling battery scrap according to claim 5, further comprising:
continuing to apply voltage to maintain a constant current until a rise in voltage indicates depletion of the first transition metal oxide from the melt; and
removing the first cathode with first electroplated transition metal from the melt.

7. A process for recycling battery scrap containing one or more transition metal oxides comprising:
submerging the battery scrap in a melt comprising a glass-forming oxide, the melt being contained in an extraction cell;
holding the melt at a temperature between about 600° C. and about 1100° C., thereby allowing the oxides of the one or more transition metals to dissolve in the melt;
configuring a liquid metal cathode in the melt, the liquid metal cathode comprising liquid metal at the temperature of the melt;
configuring an anode in the melt;
applying a voltage across the anode and the liquid metal cathode, thereby generating oxygen at the anode and reducing the one or more transition metals at the liquid metal cathode, the reduced transition metals forming a liquid metal alloy with the liquid metal in the liquid metal cathode; and
processing the liquid metal alloy to extract the one or more transition metals from the liquid metal alloy.

8. The process for recycling battery scrap containing one or more transition metal oxides according to claim 7, wherein processing the liquid metal alloy to extract the one or more transition metals comprises the refining steps of:
pooling the liquid metal alloy containing the one or more transition metals at the bottom of a refiner cell, the refiner cell further having a molten salt covering the pooled liquid metal alloy, wherein the liquid metal alloy is electrically configured as an anode in the refiner cell, wherein the melting temperature of the molten salt electrolyte is less than 300° C., and wherein the operating temperature of the refiner cell is greater than the melting temperature of the molten salt electrolyte and of the liquid metal alloy but less than the melting temperatures of the one or more transition metals that are present in the liquid metal alloy;
configuring a first electrically conductive substrate to function as a first refiner cell cathode; and
passing a current across the first electrically conductive substrate and the liquid metal alloy, causing a first transition metal to electroplate onto the first electrically conductive substrate.

9. The process for recycling battery scrap containing one or more transition metal oxides according to claim 8, further comprising the steps of:
monitoring electrical properties to determine when the first transition metal has been depleted from the molten salt electrolyte; and
removing the first electrically conductive substrate coated with the first transition metal in order to recover the first transition metal in pure form,
wherein the electrical properties monitored are selected from the group consisting of current, voltage, time derivatives of current, time derivatives of voltage, and combinations thereof.

10. The process for recycling battery scrap containing one or more transition metal oxides according to claim 9, further comprising the steps of:
configuring a second electrically conductive substrate to function as a second refiner cell cathode; and
passing a current across the second electrically conductive substrate and the liquid metal alloy, causing a second transition metal to electroplate onto the second electrically conductive substrate.

11. The process for recycling battery scrap containing one or more transition metal oxides according to claim 10, further comprising the steps of:
monitoring electrical properties to determine when the second transition metal has been depleted from the molten salt electrolyte; and
removing the second electrically conductive substrate coated with the second transition metal in order to recover the second transition metal in pure form, wherein the electrical properties monitored are selected from the group consisting of current, voltage, time derivatives of current, time derivatives of voltage, and combinations thereof.

12. The process for recycling battery scrap containing one or more transition metal oxides according to claim 11, further comprising the steps of:
configuring successive electrically conductive substrates to function as successive refiner cell cathodes;
passing a current across successive electrically conductive substrates and the liquid metal alloy, causing successive transition metals to electroplate onto successive electrically conductive substrates;
monitoring electrical properties to determine when the successive transition metals have been depleted from the molten salt electrolyte; and
removing successive electrically conductive substrates coated with successive transition metals in order to recover successive transition metals in pure form, wherein the electrical properties monitored are selected from the group consisting of current, voltage, time derivatives of current, time derivatives of voltage, and combinations thereof.

13. The process for recycling battery scrap containing one or more transition metal oxides according to claim 1, wherein the glass-forming oxide is selected from the group consisting of borate, pyrophosphate, silicate, and combinations thereof.

14. The process for recycling battery scrap containing one or more transition metal oxides according claim 1, wherein the melt further comprises Na₂O.

15. The process for recycling battery scrap containing one or more transition metal oxides according to claim 1, wherein the melt further comprises NaF.

16. The process for recycling battery scrap containing one or more transition metal oxides according to claim 1, wherein the glass-forming oxide comprises borate.

17. The process for recycling battery scrap containing one or more transition metal oxides according to any of claim 1, wherein the glass-forming oxide comprises pyrophosphate.

18. The process for recycling battery scrap containing one or more transition metal oxides according to any of claim 1 wherein the transition metal forming the transition metal oxide is selected from the group consisting of cobalt, nickel, manganese, and combinations thereof.

19. The process for recycling battery scrap containing one or more transition metal oxides according to claim 1, wherein the battery scrap comprises material from lithium batteries.

20. The process for recycling battery scrap containing one or more transition metal oxides according to claim 1, wherein the battery scrap comprises lithium depleted battery scrap.

21. A process for obtaining lithium metal and lithium depleted battery scrap from battery scrap containing lithium in ionic or metallic form comprising:
configuring the battery scrap as an anode in an electrolytic cell;
configuring an electrically conductive substrate as a cathode in the electrolytic cell, the electrically conductive substrate being coated with a lithium ion selective elastomeric polymer;
disposing a molten salt electrolyte in the electrolytic cell, such that the anode and the elastomeric polymer coated electrically conductive substrate are submerged in the molten salt electrolyte, wherein the melting temperature of the molten salt electrolyte is less than 140° C.; and
applying a voltage across the anode and the electrically conductive substrate, the voltage causing a layer of lithium metal to deposit on the surface of the electrically conductive substrate, with the layer of lithium metal being sandwiched between the electrically conductive substrate and the elastomeric polymer coating, thereby providing the lithium metal in a form suitable for further processing, and the lithium depleted battery scrap.

22. A process for recycling lithium battery scrap containing one or more transition metal oxides, the process comprising:
configuring the battery scrap as a first anode in an electrolytic cell;
configuring an electrically conductive substrate as a first cathode in the electrolytic cell, the electrically conductive substrate being coated with a lithium ion selective elastomeric polymer;
disposing a first molten salt electrolyte in the electrolytic cell;
applying a voltage across the anode and the electrically conductive substrate, the voltage causing a layer of lithium metal to deposit on the surface of the electrically conductive substrate, with the layer of lithium metal being sandwiched between the electrically conductive substrate and the elastomeric polymer coating, thereby providing the lithium metal in a form suitable for further processing, and lithium depleted battery scrap;
removing the lithium depleted battery scrap from the first molten salt electrolyte;
submerging the lithium depleted battery scrap in a melt comprising a glass-forming oxide, the melt being contained in an extraction cell;
holding the melt at a temperature that allows the oxides of the one or more transition metals to dissolve in the melt;
configuring a second cathode in the melt;
configuring a second anode in the melt; and
applying a voltage across the second anode and the second cathode, thereby generating oxygen at the second anode and reducing the one or more transition metals at the second cathode for recovery.
